(19) United States
(12) Patent Application Publication
(10) Pub. No.: US 2025/0033453 A1
(43) Pub. Date: Jan. 30, 2025

(54) EXHAUST MOUNTING

(71) Applicant: JAGUAR LAND ROVER LIMITED, Whitley (GB)

(72) Inventor: Niall SHIMMIN, Coventry (GB)

(21) Appl. No.: 18/361,211

(22) Filed: Jul. 28, 2023

(51) Int. Cl. B60K 1/04; H01M 50/249; H01M 50/262; H01M 50/358

(52) U.S. Cl. CPC B60K 1/04; H01M 50/249; H01M 50/262; H01M 50/358; B60K 2001/0438; H01M 2220/20

(57) ABSTRACT

The disclosure relates to a vehicle subassembly for supporting an exhaust by a battery. In particular, the vehicle subassembly supports an exhaust extending between a battery and an underbody of a vehicle. The disclosure also relates to an exhaust mounting assembly, and to a vehicle.

### TECHNICAL FIELD

The present disclosure relates to an exhaust mounting. More specifically, the present disclosure relates to a mount for an exhaust of a hybrid electric vehicle, and in particular a plug-in hybrid electric vehicle. Aspects of the invention relate to a vehicle subassembly, an exhaust mounting assembly, and to a vehicle.

### BACKGROUND

Plug-in hybrid electric vehicles (PHEV) combine a traditional internal combustion engine powertrain system with an on-board battery that can be charged through connection with mains electricity.

PHEVs provide a number of challenges when attempting to package traditional powertrain components alongside a battery, due to the size of the battery required.

This is primarily as a result of space constraints in the underside of a vehicle and is a particular challenge in the case of front engine vehicles, as the exhaust must generally extend along part of the length of the vehicle from the engine to the rear.

### SUMMARY OF THE INVENTION

It is an aim of the present invention to address one or more of the disadvantages associated with the prior art.

A broad aspect relates to a vehicle subassembly comprising: a vehicle underbody; a battery; an exhaust extending between the vehicle underbody and the battery; and an exhaust mounting assembly comprising: a battery mounting element secured to the battery; and an exhaust mounting arm having a first end secured to the battery mounting element and a second end secured to the exhaust.

A broad aspect relates to a vehicle subassembly comprising: a vehicle underbody; a battery; an exhaust comprising a plurality of exhaust sections and extending between the vehicle underbody and the battery; and an exhaust mounting assembly comprising: a battery mounting element secured to the battery; and an exhaust mounting arm having a first end secured to the battery mounting element and a second end secured to the exhaust at an interface between two sections of the exhaust.

A broad aspect relates to a vehicle subassembly comprising: a vehicle underbody; a battery; an exhaust extending between the vehicle underbody and the battery; and an exhaust mount comprising: a battery mounting element secured to the battery; and an exhaust mounting arm having a first end secured to the battery mounting element and a second end secured to the exhaust.

A broad aspect relates to a vehicle subassembly comprising: a vehicle underbody; a battery; an exhaust positioned between the vehicle underbody and the battery; and an exhaust mounting assembly comprising: a battery mount secured to the battery; and an exhaust mounting arm having a first end secured to the battery mount and a second end secured to the exhaust.

A broad aspect relates to a vehicle subassembly comprising: a vehicle underbody; a battery; an exhaust positioned between the vehicle underbody and the battery; and an exhaust mount comprising: a battery mount secured to the battery; and an exhaust mounting arm having a first end secured to the battery mount and a second end secured to the exhaust.

A broad aspect relates to a vehicle subassembly comprising: a vehicle underbody; a battery; an exhaust extending between the vehicle underbody and the battery; and an exhaust mounting assembly comprising a first end secured to the battery and a second end secured to the exhaust.

A broad aspect relates to a vehicle subassembly comprising: a vehicle underbody; a battery; an exhaust extending between the vehicle underbody and the battery; and an exhaust mounting assembly comprising a first portion secured to the battery and a second portion secured to the exhaust.

A broad aspect relates to a vehicle subassembly comprising: a vehicle underbody; a battery; an exhaust extending between the vehicle underbody and the battery; and an exhaust mount comprising a first end secured to the battery and a second end secured to the exhaust.

A broad aspect relates to a vehicle subassembly comprising: a vehicle underbody; a battery; an exhaust extending between the vehicle underbody and the battery; and an exhaust mount comprising a first portion secured to the battery and a second portion secured to the exhaust.

A broad aspect relates to a vehicle subassembly comprising: a vehicle underbody; a battery frame for securing a battery to a vehicle; an exhaust extending between the vehicle underbody and the battery frame; and an exhaust mounting assembly comprising: a battery mounting element secured to the battery frame; and an exhaust mounting arm having a first end secured to the battery mounting element and a second end secured to the exhaust.

A broad aspect relates to a vehicle subassembly comprising: a vehicle underbody; a battery frame for securing a battery to a vehicle; an exhaust extending between the vehicle underbody and the battery frame; and an exhaust mounting assembly comprising: a battery mount secured to the battery frame; and an exhaust mounting arm having a first end secured to the battery mount and a second end secured to the exhaust.

A broad aspect relates to a vehicle subassembly comprising: a vehicle underbody; a battery frame for securing a battery to a vehicle; an exhaust extending between the vehicle underbody and the battery frame; and an exhaust mounting assembly comprising a first end secured to the battery frame and a second end secured to the exhaust.

A broad aspect relates to a vehicle comprising: a vehicle underbody; a battery; an exhaust extending between the vehicle underbody and the battery; and an exhaust mounting assembly comprising: a battery mounting element secured to the battery; and an exhaust mounting arm having a first end secured to the battery mounting element and a second end secured to the exhaust.

A broad aspect relates to a plug-in hybrid electric vehicle subassembly comprising: a vehicle underbody; a battery; an exhaust extending between the vehicle underbody and the battery; and an exhaust mounting assembly comprising: a battery mounting element secured to the battery; and an exhaust mounting arm having a first end secured to the battery mounting element and a second end secured to the exhaust.

A broad aspect relates to a vehicle subassembly comprising: a vehicle floor; a battery module; an exhaust extending between the vehicle floor and the battery module; and an exhaust mounting assembly comprising: a battery mounting element secured to the battery module; and an exhaust mounting arm having a first end secured to the battery mounting element and a second end secured to the exhaust.

A broad aspect relates to a vehicle subassembly comprising: a vehicle floor; a battery module; an exhaust extending between the vehicle floor and the battery module; and an exhaust mounting assembly comprising: a first portion secured to the battery module; and an exhaust mounting arm having a first end secured to the first portion and a second end secured to the exhaust.

A broad aspect relates to a vehicle subassembly comprising: a battery frame for securing a battery to a vehicle; an exhaust held in a position relative to the battery frame by an exhaust mounting assembly, wherein the exhaust mounting assembly comprises: a battery mounting element secured to the battery frame; and an exhaust mounting arm having a first end secured to the battery mounting element and a second end secured to the exhaust.

A broad aspect relates to a vehicle subassembly comprising: a battery; an exhaust held in a position relative to the battery by an exhaust mounting assembly, wherein the exhaust mounting assembly comprises: a battery mounting element secured to the battery; and an exhaust mounting arm having a first end secured to the battery mounting element and a second end secured to the exhaust.

A broad aspect relates to a vehicle subassembly comprising: a battery; an exhaust held in a position relative to the battery by an exhaust mount, wherein the exhaust mount comprises: a battery mounting element secured to the battery; and an exhaust mounting arm having a first end secured to the battery mounting element and a second end secured to the exhaust.

A broad aspect relates to a vehicle subassembly comprising: a battery; an exhaust held in a position relative to the battery by an exhaust mount, wherein the exhaust mount comprises: a battery mount secured to the battery; and an exhaust mounting arm having a first end secured to the battery mount and a second end secured to the exhaust.

A broad aspect relates to a vehicle subassembly comprising: a battery frame for securing a battery to a vehicle; an exhaust extending past the battery frame; and an exhaust mounting assembly comprising: a battery mounting element secured to the battery frame; and an exhaust mounting arm having a first end secured to the battery mounting element and a second end secured to the exhaust.

A broad aspect relates to a vehicle subassembly comprising: a battery; an exhaust positioned adjacent the battery; and an exhaust mounting assembly comprising: a battery mounting element secured to the battery; and an exhaust mounting arm having a first end secured to the battery mounting element and a second end secured to the exhaust.

A broad aspect relates to an exhaust mounting assembly comprising: a body having an aperture; a battery mounting assembly extending from the body, wherein the battery mounting assembly comprises one or more fasteners for connection to a battery frame; and an exhaust mounting arm having a first end secured within the aperture of the body and a second end for connection to an exhaust.

A broad aspect relates to an exhaust mount comprising: a body; a battery mounting assembly extending from the body, wherein the battery mounting assembly comprises one or more fasteners for connection to a battery frame; and an exhaust mounting arm having a first end secured to the body and a second end for connection to an exhaust.

A broad aspect relates to an exhaust mounting assembly comprising: a body having an aperture; a battery mount extending from the body, wherein the battery mount comprises one or more fasteners for connection to a battery; and an exhaust mounting arm having a first end secured within the aperture of the body and a second end for connection to an exhaust.

A broad aspect relates to an exhaust mount comprising: a body having an aperture and a battery mount, wherein the battery mount comprises one or more fasteners for connection to a battery; and an exhaust mounting arm having a first end secured within the aperture of the body and a second end for connection to an exhaust.

According to an aspect of the invention, there is provided a vehicle comprising the vehicle subassembly described above or the exhaust mounting assembly described above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows an end view of a vehicle subassembly according to an embodiment of the invention;

FIG. 2 shows a detail view of part of the vehicle subassembly of FIG. 1 absent the battery;

FIG. 3 shows a side view of the exhaust mounting assembly of FIG. 1;

FIG. 4 shows a side view of the exhaust mounting assembly of FIG. 3 shown from a side opposite the side shown in FIG. 3;

FIG. 5 shows a side view of the exhaust mounting assembly of FIG. 3 secured to a battery frame;

FIG. 6 shows a side view of the exhaust mounting assembly of FIG. 3 secured to a battery frame shown from a side opposite the side shown in FIG. 5;

FIG. 7 shows a side perspective view of the body of the exhaust mounting assembly of FIG. 3;

FIG. 8 shows an alternative side perspective view of the body of the exhaust mounting assembly of FIG. 3 shown from a side opposite the side shown in FIG. 7;

FIG. 9 shows a perspective view of an exhaust mounting arm forming part of the exhaust mounting assembly of FIG. 3; and

FIG. 10 shows a vehicle in accordance with an embodiment of the invention.

### DETAILED DESCRIPTION

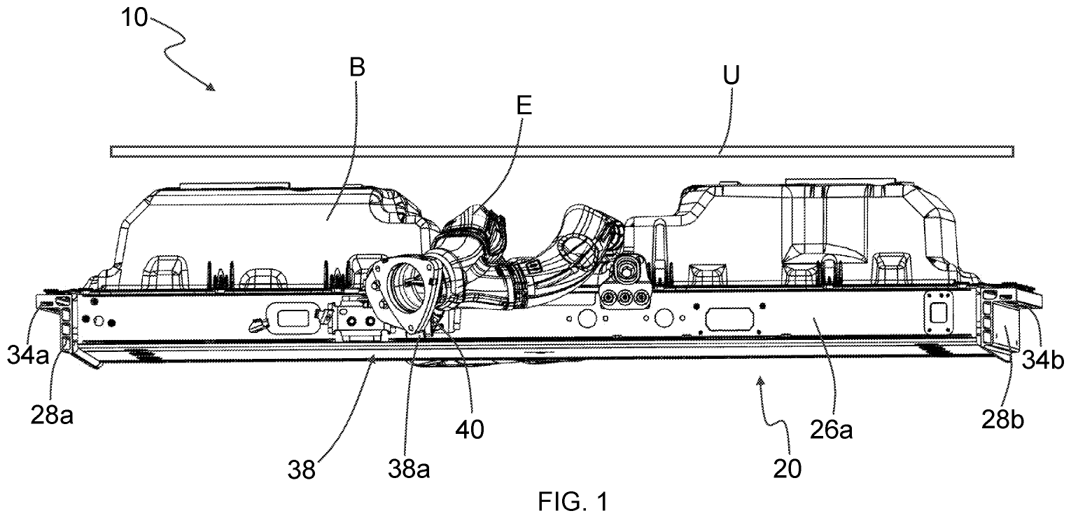

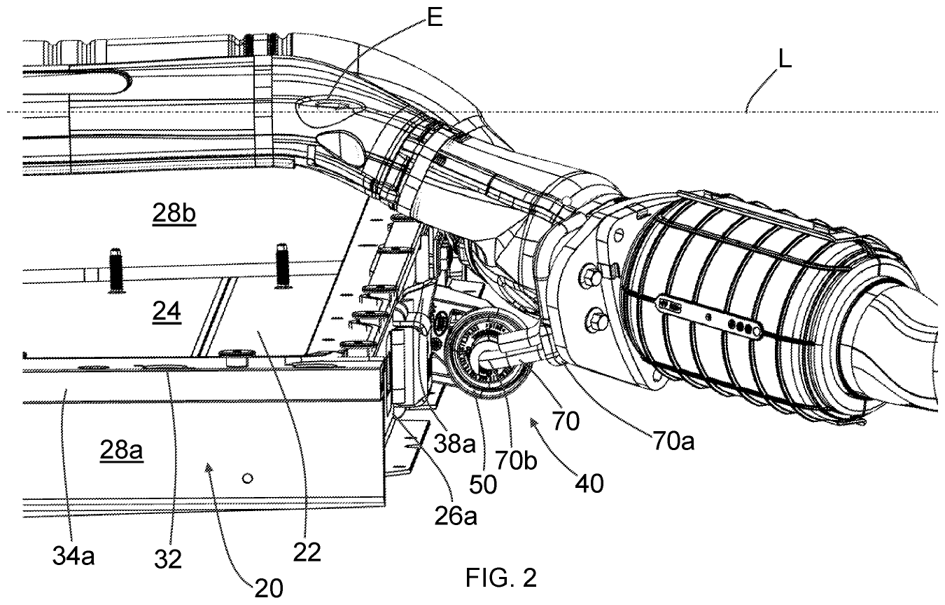

A vehicle subassembly 10 in accordance with an embodiment of the invention is described herein with reference to accompanying FIGS. 1 and 2.

The vehicle subassembly 10 includes a battery frame 20 for securing a battery B (FIG. 1) to a vehicle underbody U (FIG. 1). An exhaust E is positioned between the battery B and the vehicle underbody U, and extends generally along a longitudinal axis L. The vehicle subassembly 10 further includes an exhaust mounting assembly 40 secured to each of the battery frame 20 and the exhaust E. The exhaust mounting assembly 40 forms a structural connection between the exhaust E and the battery frame 20, such that the battery frame 20 supports the weight of the exhaust E in this embodiment.

The exhaust mounting assembly 40 includes a battery mounting element 50 including a body 51 secured to the battery frame 20. An exhaust mounting arm 70 has a first end 70a secured to the body 51 and a second end 70b secured to the exhaust E.

It will be appreciated that the exhaust mounting assembly 40 may be replaced with an exhaust mount. Furthermore, the vehicle subassembly 10 may not include a vehicle underbody U.

As will be described in greater detail hereinafter, the vehicle subassembly provides a support for an exhaust located between a battery and vehicle underbody. This has particular application in front engine plug-in hybrid electric vehicles, where a battery and exhaust must be packaged within a restricted or confined space and the exhaust may pass over or through the battery. It will be appreciated that the vehicle subassembly 10 would also find application in other vehicle types.

The vehicle subassembly 10 may be replaced with a vehicle assembly or a vehicle. The vehicle may be replaced with an automobile or road vehicle.

The vehicle underbody U may be replaced with a vehicle chassis, a vehicle undertray, a vehicle body, a vehicle floor or a vehicle structure.

The battery frame 20 comprises a tray 22 having a floor 24. The tray 22 is generally rectangular when viewed in plan and is configured to receive and/or support the battery B, in use. The battery frame 20 is shown with a battery B (FIG. 1) positioned within the tray 22 in this embodiment, and located between the floor 24 and the vehicle underbody U. It will be appreciated that the battery frame 20 may comprise one or more batteries that, in use, are at least partially received within the tray 22 or are mounted to a periphery of the battery frame 20. The tray 22 may be replaced with a receptacle or a housing.

The tray 22 describes an internal volume and is defined by a first widthwise extending beam 26a, a second widthwise extending beam (not shown), a first longitudinally extending beam 28a and a second longitudinally extending beam 28b. Each of the beams 26a, 28a, 28b comprises an extruded aluminium profile and the beams together describe an outer periphery of the tray 22. It will be appreciated that one or more of the beams may be formed of another suitable material. It will also be appreciated that one or more of the beams may be formed by rolling, printing or casting.

The first and second widthwise extending beams are spaced from one another along the longitudinal axis L of the exhaust E and extend across a portion of a width of a vehicle 200 (FIG. 10), in use. In use, the first widthwise extending beam 26a is located closer to a rear of a vehicle than the second widthwise extending beam.

Each of the first and second longitudinally extending beams 28a, 28b includes a battery frame mounting assembly. The battery frame mounting assembly includes a plurality of holes 32 extending through a respective ledge 34a, 34b of each of the first and second longitudinally extending beams 28a, 28b. The battery frame mounting assembly also includes a plurality of fasteners (not shown) configured to extend through the holes 32 and into a vehicle body or chassis. The fasteners may comprise screws or bolts and may extend into a vehicle sill.

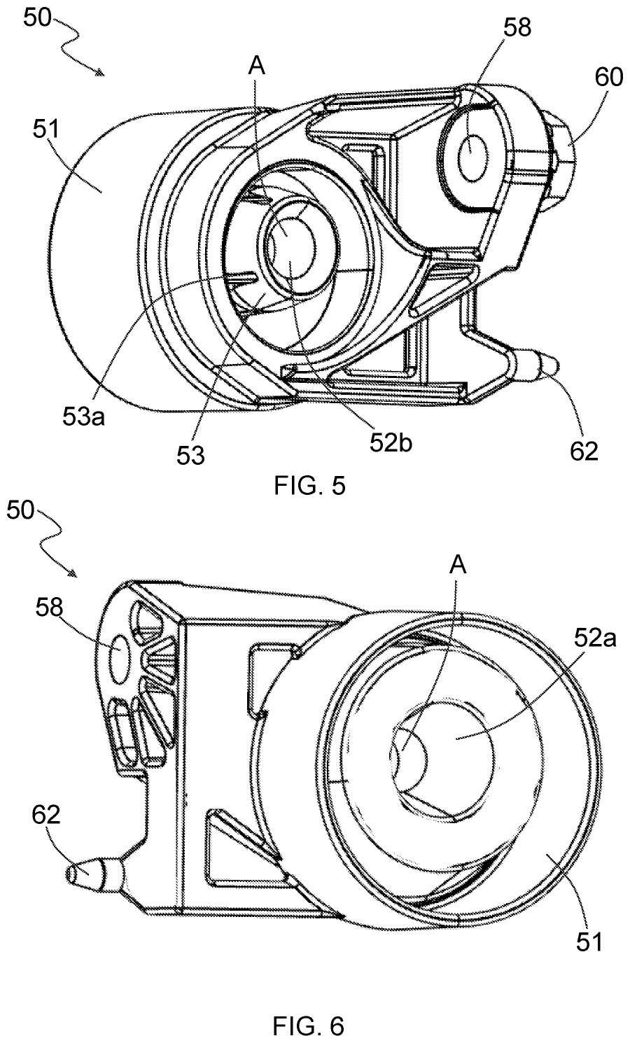

Three support brackets 38 are located on the first widthwise extending beam 26a to the outside of the internal volume V defined by the tray 22. A central one of the three support brackets 38a, shown more clearly in FIGS. 5 and 6, has the body 51 of the exhaust mounting assembly 40 secured thereto.

The skilled person will appreciate that the battery frame 20 as described, may instead be replaced by a battery casing, a battery housing or a battery module. Furthermore, the battery frame 20 as described may contain, comprise or receive a battery casing, a battery housing or a battery module.

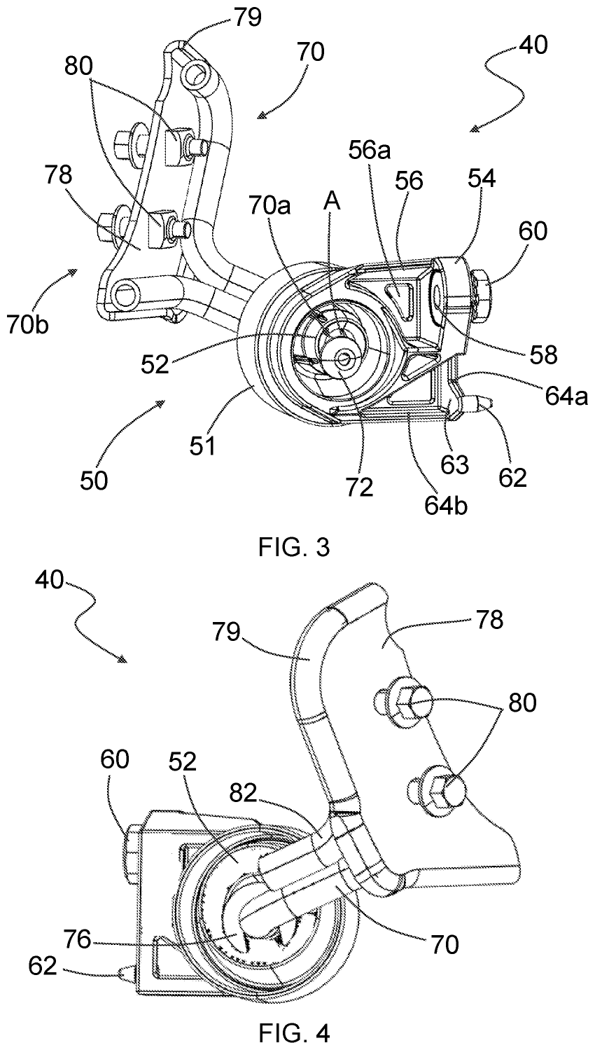

Referring now to FIGS. 3 and 4, there is shown the exhaust mounting assembly 40 in greater detail.

The exhaust mounting assembly 40 includes a battery mounting element 50 including a substantially annular body 51 (hereinafter body) having an elastomeric insert 52 is received therein. The body 51 is formed of an aluminium alloy in this embodiment, but it will be appreciated that it may instead be formed of another suitable material.

The elastomeric insert 52 press-fit within the body 51 and is annular in this embodiment. An aperture A extends through the elastomeric insert 52. As is shown in FIGS. 5 and 6 in particular, the aperture A extends through the elastomeric insert 52 from a first side 52a to a second side 52b. The aperture A tapers from the first side 52a to the second side 52b such that the diameter is greater at the first side 52a than the second 52b. The second side 52b is provided with a conical portion 53 having a plurality of stiffening ribs 53a extending therefrom. The elastomeric insert 52 may be formed of rubber.

A mounting flange 54 extends from the body 51 and is connected thereto by a web 56. The web has an aperture 56a to help minimise the mass of the exhaust mounting assembly 40. A mounting aperture 58 extends through the flange 54 and has a central axis generally perpendicular to a central axis of the aperture A. The mounting aperture 58 is configured to receive a fastener (not shown) that engages a clinch nut 60 located adjacent the mounting aperture 58 on the other side of the mounting flange 54 than the body 50. The fastener may be a screw or a bolt that extends through the mounting aperture 58.

In use, a portion of the support bracket 38a is positioned between the mounting flange 54 and the clinch nut 60 in order to secure the exhaust mounting assembly 40 to the battery frame 20.

An anti-rotation pin 62 extends from a flange 63 that is connected to each of the body 51 and the mounting flange 54 by a respective web 64a, 64b. A shown in greater detail in FIG. 8, the anti-rotation pin 62 is received within an aperture 39 of the support bracket 38a and is configured to prevent rotation of the body 51 about the central axis of the mounting aperture 58. The anti-rotation pin 62, and aperture 39, is spaced from the central axis of the mounting aperture 58. Furthermore, the anti-rotation 62 may be located within the aperture 39 during assembly of the vehicle subassembly 10 such that rotation of the body 51 is restricted, for example as the clinch nut 60 is rotated.

The battery mounting element 50 is shown in greater detail, and in isolation, in FIGS. 5 and 6.

Referring now to FIGS. 3, 4 and 7, the exhaust mounting assembly 40 also includes an exhaust mounting arm 70. As stated above, the exhaust mounting arm 70 has a first end 70a secured to the body 51 and a second end 70b secured to the exhaust E. The exhaust mounting arm 70 is generally U-shaped in this embodiment and has a first portion 71a extending between the first end 70a and a first elbow 71b, a second portion 71c extending between the first elbow 71b and a second elbow 71d, and a third portion 71e extending between the second elbow 71d and the second end 70b. The first elbow 71b and the second elbow 71d are arranged such that the first portion 71a and the third portion 71e diverge in a direction away from the second portion 71c.

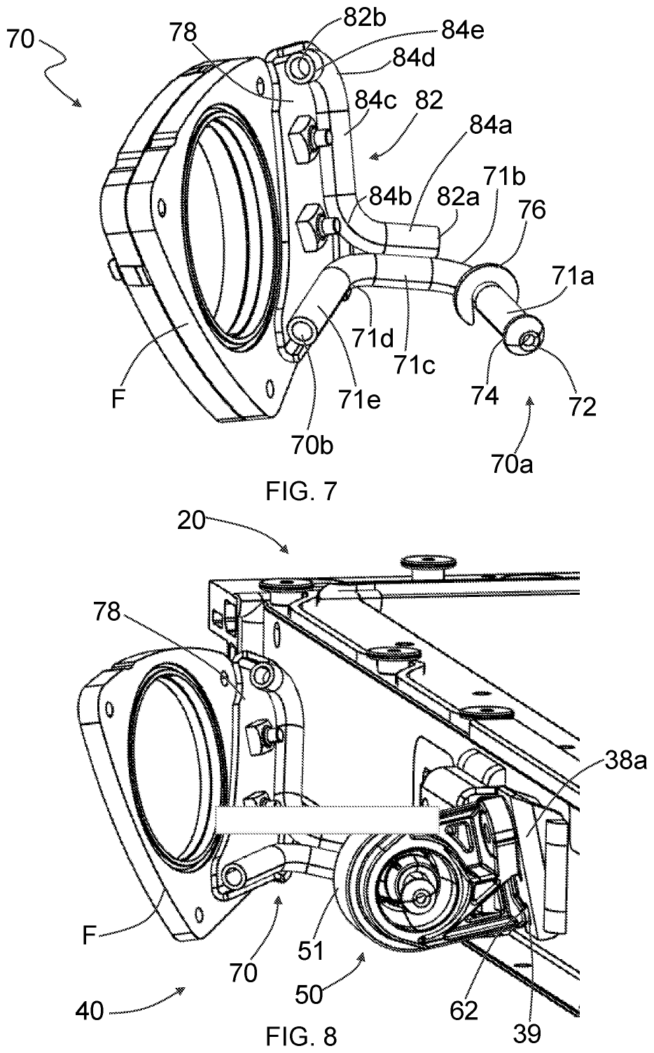

The exhaust mounting arm 70 has an enlarged head 72 provided at the first end 70a that includes an annular abutment surface 74 (shown in FIG. 7). The enlarged head 72 is received within the aperture A such that it extends from the second side 52b of the elastomeric insert 52. The enlarged head 72 and the annular abutment surface 74 have a diameter greater than the diameter of the aperture A at the second side 52b such that the annular abutment surface 74 abuts a free end of the conical portion 53. This abutment surface 74 and conical portion 53 secures the exhaust mounting arm 70 within the body 51 and prevents inadvertent removal of the exhaust mounting arm 70 from the battery mounting element 50, in use.

The exhaust mounting arm 70 also includes a retaining collar 76 adjacent the first elbow 70b and spaced from the enlarged head 72. The retaining collar 76 has a diameter greater than the diameter of the aperture A at the first side 52a, and is spaced from the annular abutment surface 74 a distance generally equal to the length of the aperture A taken along its central axis. The retaining collar 76 is configured to abut the elastomeric insert 52 at the first side 52a, which together with the annular abutment surface 74 is configured to prevent or resist translation of the exhaust mounting arm 70 along the central axis of the aperture A.

The second end 70b of the exhaust mounting arm 70 is connected to a mounting plate 78 having two fasteners 80 for connection with an exhaust E (FIG. 1). The fasteners 80 each extend through a respective aperture formed in the mounting plate 78. Specifically, as shown in FIG. 7, the mounting plate 78 is configured to be connected to a flange F located at the interface between two sections of the exhaust E. It will be appreciated that the mounting plate 78 may be replaced by a flange.

A stiffening member 82 is connected to the exhaust mounting arm 70. The stiffening member 82 has a first end 82a connected to the second portion 71c between the first elbow 71b and the second elbow 71d. The stiffening member 82 has a second end 82b connected to the mounting plate 78. The stiffening member 82 has a first portion 84a welded to the second portion 71c of the exhaust mounting arm 70 and extending parallel thereto. The first portion 84a extends between the first end 82a and a first elbow 84b. A second portion 84c extends between the first elbow 84b and a second elbow 84d and is generally perpendicular to the first portion 84a. A third portion 84e extends between the second elbow 84d and the second end 82b and is generally parallel with, and rotationally offset from, the first portion 84a. The exhaust mounting arm 70 and the stiffening member 82 diverge from one another towards their respective second ends 70b, 82b.

The mounting plate 78 has a peripheral lip 79 and a portion of each of the exhaust mounting arm 70 and stiffening member 82 is positioned adjacent the peripheral lip 79. It will be appreciated that the exhaust mounting arm 70 may comprise the stiffening member 82.

The second end 70b of the exhaust mounting arm 70 and the second end 82b of the stiffening member 82 are each welded to the mounting plate 78 in this embodiment. Furthermore, each of the exhaust mounting arm 70 and stiffening member 82 are elongate hollow tubes in this embodiment.

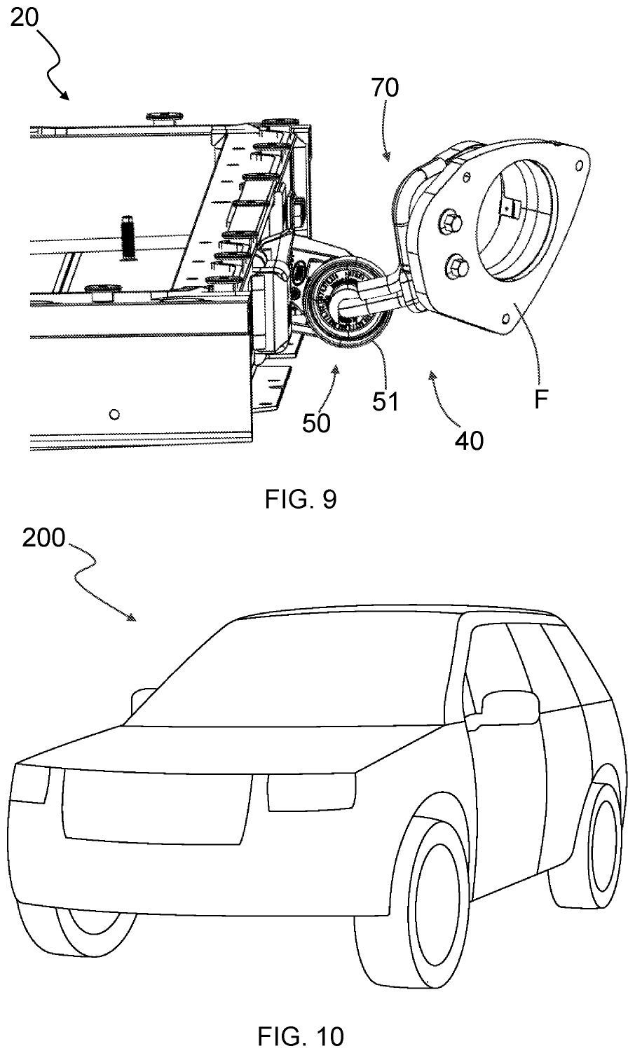

FIGS. 8 and 9 show the exhaust mounting assembly 10 described above secured to a battery frame 20 and with the anti-rotation pin 62 received within the aperture 39 of the support bracket 38a. The exhaust mounting arm 70 is connected to a flange F of an exhaust via the mounting plate 78. The flange F is configured to be located at the interface between two sections of the exhaust E (FIG. 1).

FIG. 10 illustrates a vehicle 200 according to an embodiment of the present invention. The vehicle 200 comprises a vehicle subassembly 10 as illustrated in FIGS. 1 and 2.

It will be appreciated that various changes and modifications can be made to the present invention without departing from the scope of the present application.

1. A vehicle subassembly, comprising:
a vehicle underbody;
a battery;
an exhaust extending between the vehicle underbody and the battery; and
an exhaust mounting assembly comprising:
a battery mounting element secured to the battery; and
an exhaust mounting arm having a first end secured to the battery mounting element and a second end secured to the exhaust.

2. The vehicle subassembly according to claim 1, wherein the exhaust mounting assembly comprises a body having an aperture extending therethrough, and further wherein the first end of the exhaust mounting arm is secured within the aperture.

3. The vehicle subassembly according to claim 2, wherein the body is substantially annular.

4. The vehicle subassembly according to claim 2, comprising an elastomeric insert received within the body and wherein the aperture extends through the elastomeric insert.

5. The vehicle subassembly according to claim 2, comprising an enlarged portion at the first end of the exhaust mounting arm, and wherein the enlarged portion is larger than the aperture.

6. The vehicle subassembly according to claim 1, wherein the second end of the exhaust mounting arm is connected at an interface between two sections of the exhaust.

7. The vehicle subassembly according to claim 6, wherein the second end of the exhaust mounting arm comprises a flange located between two sections of the exhaust.

8. The vehicle subassembly according to claim 2, wherein the battery mounting element comprises a mounting flange extending from the body.

9. The vehicle subassembly according to claim 8, comprising a web extending between the body and the mounting flange.

10. The vehicle subassembly according to claim 8, wherein the mounting flange comprises an aperture, and further wherein a fastener extends through the aperture to secure the exhaust mounting assembly to the battery.

11. The vehicle subassembly according to claim 10, wherein a longitudinal axis of the aperture of the mounting flange extends substantially perpendicular to a longitudinal axis of the aperture of the body.

12. The vehicle subassembly according to claim 10, wherein the fastener comprises a clinch nut.

13. The vehicle subassembly according to claim 2, wherein the battery comprises an aperture and the exhaust mounting assembly comprises an anti-rotation pin extending from the body and received within the aperture, wherein the aperture is spaced from a location at which the exhaust mounting assembly is secured to the battery.

14. The vehicle subassembly according to claim 13, wherein the anti-rotation pin extends from a flange.

15. The vehicle subassembly according to claim 1, wherein the exhaust mounting assembly is formed of an aluminium alloy.

16. The vehicle subassembly according to claim 1, wherein the exhaust mounting assembly is die cast.

17. The vehicle subassembly according to claim 1, wherein the exhaust mounting arm comprises an elbow.

18. A vehicle subassembly comprising:
a battery frame for securing a battery to a vehicle; and
an exhaust held in a position relative to the battery frame by an exhaust mounting assembly, wherein the exhaust mounting assembly comprises:
a battery mounting element secured to the battery frame; and
an exhaust mounting arm having a first end secured to the battery mounting element and a second end secured to the exhaust.

19. An exhaust mounting assembly comprising:
a body having an aperture;
a battery mounting assembly extending from the body, wherein the battery mounting assembly comprises one or more fasteners for connection to a battery frame; and
an exhaust mounting arm having a first end secured within the aperture of the body and a second end for connection to an exhaust.
